(19) United States
(12) Patent Application Publication
(10) Pub. No.: US 2026/0017801 A1
(43) Pub. Date: Jan. 15, 2026

(54) DATA PROCESSING DEVICE, DISTANCE IMAGE CAPTURING DEVICE, AND EDGE DETECTION METHOD

(71) Applicant: TOPPAN Holdings Inc., Tokyo (JP)

(72) Inventors: Kai HIROKAWA, Tokyo (JP); Kunihiro HATAKEYAMA, Tokyo (JP)

(73) Assignee: TOPPAN Holdings Inc., Tokyo (JP)

(21) Appl. No.: 19/262,394

(22) Filed: Jul. 8, 2025

(30) Foreign Application Priority Data
Jul. 10, 2024 (JP) 2024-110940

(51) Int. Cl. G06T 7/13

(52) U.S. Cl. CPC G06T 7/13; G06T 2207/10028

(57) ABSTRACT

A data processing device includes an acquisition unit configured to acquire a distance image based on the distance to an object in a space to be measured, and an edge detection unit configured to perform edge detection on respective pixels of the distance image based on the ratio between distance values of the respective pixels or some pixels among a plurality of pixels around the respective pixels.

### CROSS REFERENCE TO RELATED APPLICATIONS

This application claims the benefit of priority based on Japanese Patent Application No. 2024-110940, filed on Jul. 10, 2024, in the Japan Patent Office. The contents of the Japanese Patent Application are incorporated herein by reference.

### BACKGROUND OF THE INVENTION

### Field of the Invention

The present disclosure relates to a data processing device, a distance image capturing device, and an edge detection method.

### Description of Related Art

A distance image capturing device of a time of flight (hereinafter, referred to as “TOF”) method is implemented to measure the distance between a measuring device and a target object based on a time of flight of light in a space (measurement space) by using a known speed of light (for example, refer to Japanese Patent No. 4235729). In such a distance image capturing device, a delay time from a point in time when a light pulse is emitted to a point in time when a light pulse reflected by an object returns is obtained by accumulating electric charges generated by a photoelectric conversion element in a plurality of charge accumulation units, and the distance to the object is calculated by using the delay time and speed of light.

In a distance image obtained by such a distance image capturing device, when the reflected light of a front target and a rear target is incident on one pixel at edges of a plurality of targets (measurement targets) at different distances, a flying pixel (FP) can occur. In general, there is a method of detecting an edge by filtering based on a difference between adjacent pixels by using a differential filter such as a Sobel filter, setting a threshold for the size of the edge, and removing a pixel having an edge greater than or equal to the threshold, as an FP.

### SUMMARY OF THE INVENTION

However, in an edge detection using a difference between adjacent pixels as described above, there is a problem in that, when the threshold is set to be small, an FP can be removed by a small edge, but the number of unnecessary invalid pixels other than the FP is increased, and when the threshold is set to be large, the number of unnecessary invalid pixels is reduced, but an FP of a small edge remains. Accordingly, a method of more appropriately performing edge detection is desired.

The present disclosure is made in view of the above-described problems, and an object of the present disclosure is to provide a data processing device, a distance image capturing device, and an edge detection method that can appropriately perform edge detection in a distance image.

A data processing device according to an aspect of the present disclosure includes an acquisition unit that acquires a distance image based on a distance to an object in a space to be measured, and an edge detection unit that performs edge detection on each pixel of the distance image based on a ratio of distance values of the pixel or of any plurality of pixels around the pixel.

In addition, a distance image capturing device according to an aspect of the present disclosure includes a light source unit configured to emit a light pulse to a space to be measured, a light receiving unit that includes a pixel including a photoelectric conversion element for generating electric charges according to incident light and a plurality of charge accumulation units accumulating the electric charges and a pixel drive circuit which distributes and accumulates the electric charges in each of the charge accumulation units in the pixel at a predetermined timing synchronized with emission of the light pulse, a distance calculation unit configured to acquire a distance image by calculating a distance to an object in the space based on an amount of the electric charges accumulated in each of the charge accumulation units, and an edge detection unit configured to perform edge detection on respective pixels of the distance image based on a ratio between distance values of the respective pixels or some of a plurality of pixels around the respective pixels.

In addition, an edge detection method of a distance image in a data processing device, according to an aspect of the present disclosure, includes a step of acquiring, by an acquisition unit, the distance image based on a distance to an object in a space to be measured, and a step of performing, by an edge detection unit, edge detection on respective pixels of the distance image based on a ratio between distance values of the respective pixels or some of a plurality of pixels around the respective pixels.

According to the present disclosure, it is possible to appropriately perform edge detection in a distance image.

### BRIEF DESCRIPTION OF THE DRAWINGS

FIG. 1 is a block diagram showing the schematic configuration of a distance image capturing device according to an embodiment.

FIG. 2 is a block diagram showing the schematic configuration of a distance image sensor according to an embodiment.

FIG. 3 is a circuit diagram showing an example of the configuration of a pixel of the distance image sensor according to the embodiment.

FIG. 4 is an explanatory diagram of a principle of generating a flying pixel (FP).

FIG. 5 is a diagram showing an example of a flying pixel (FP).

FIG. 6 is an explanatory diagram of an edge detection method using a Sobel filter.

FIG. 7 is a diagram showing an example of removal of flying pixels (FPs).

FIG. 8A is a view showing an example of a result of removing a flying pixel (FP) by an edge detection method of the related art.

FIG. 8B is a view showing an example of a result of removing a flying pixel (FP) by an edge detection method of the related art.

FIG. 9 is an explanatory diagram of a first example of a mechanism of trade-off.

FIG. 10A is an explanatory diagram of a second example of a mechanism of trade-off.

FIG. 10B is an explanatory diagram of a second example of a mechanism of trade-off.

FIG. 11A is explanatory diagrams showing a basic idea of edge detection according to an embodiment.

FIG. 11B is explanatory diagrams showing a basic idea of edge detection according to an embodiment.

FIG. 12 is a flowchart showing an example of edge detection processing according to an embodiment.

FIG. 13 is a diagram showing a specific calculation example of edge detection processing according to an embodiment.

FIG. 14A is a view showing an example of a result of removing a flying pixel (FP) by edge detection according to an embodiment.

FIG. 14B is a view showing an example of a result of removing a flying pixel (FP) by edge detection according to an embodiment.

FIG. 15 is a diagram showing another calculation example of edge detection processing according to an embodiment.

FIG. 16 is a diagram showing an example of a differential filter according to an embodiment.

### DETAILED DESCRIPTION OF THE INVENTION

Hereinafter, a distance image capturing device of the present embodiment will be described with reference to the drawings.

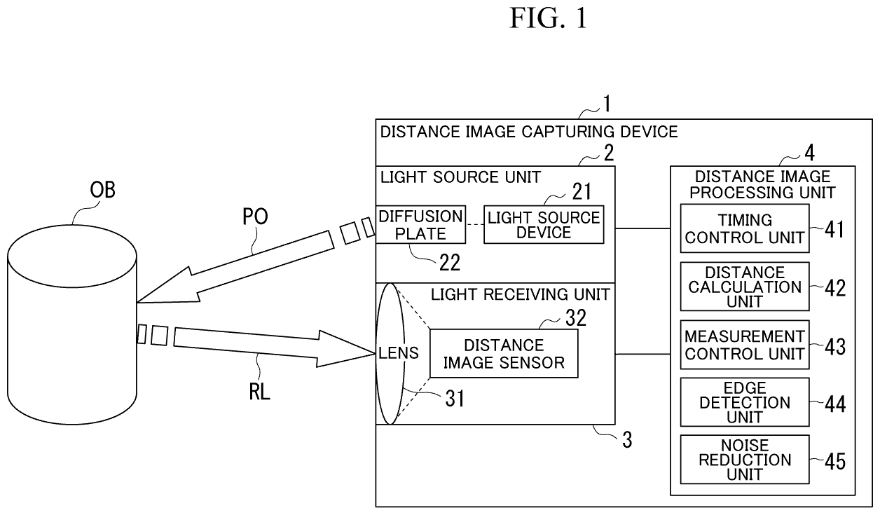

FIG. 1 is a block diagram showing the schematic configuration of a distance image capturing device according to the present embodiment. A distance image capturing device 1 measures (distance-measures) the distance to a target object by using a TOF method, and includes, for example, a light source unit 2, a light receiving unit 3, and a distance image processing unit 4. FIG. 1 also shows an object OB (subject) that is a target object of which the distance is measured by the distance image capturing device 1.

The light source unit 2 emits a light pulse PO to a space to be measured under the control of the distance image processing unit 4. For example, the light source unit 2 is a semiconductor laser module of a surface-emitting type such as vertical cavity surface emitting laser (VCSEL). The light source unit 2 includes a light source device 21 and a diffusion plate 22.

The light source device 21 is a light source which emits laser light in a near-infrared wavelength band (for example, a wavelength band having a wavelength of 850 nm to 940 nm) that is the light pulse PO emitted to a space to be measured. The light source device 21 is, for example, a semiconductor laser light emitting element. The light source device 21 emits pulsed laser light under the control of the distance image processing unit 4.

The diffusion plate 22 is an optical component that diffuses laser light in a near-infrared wavelength band emitted by the light source device 21 to a width of a surface to be emitted in the space of the measurement target. The laser light of the pulse shape diffused by the diffusion plate 22 is emitted as the light pulse PO and emitted to the space of the measurement target.

When the object OB is in a space to be measured to which the distance is measured by the distance image capturing device 1, the light receiving unit 3 receives reflected light RL of the light pulse PO emitted from the light source unit 2 and reflected by the object OB, and outputs a pixel signal corresponding to the received reflected light RL. The light receiving unit 3 includes a lens 31 and a distance image sensor 32.

The lens 31 is an optical lens that guides incident reflected light RL to the distance image sensor 32. The lens 31 emits the incident reflected light RL to the distance image sensor 32 such that the reflected light RL is received by (incident on) pixels included in a light receiving region of the distance image sensor 32.

The distance image sensor 32 is an imaging element used in the distance image capturing device 1. The distance image sensor 32 includes a plurality of pixels provided in a two-dimensional light receiving region. Each pixel of the distance image sensor 32 includes one photoelectric conversion element, a plurality of charge accumulation units corresponding to the one photoelectric conversion element, and a component that distributes electric charges to each of charge accumulation units. That is, the pixel is an imaging element having a distribution configuration by which electric charges are distributed and accumulated in a plurality of charge accumulation units.

The distance image sensor 32 distributes the electric charges generated by the photoelectric conversion element to each of charge accumulation units, under a control of the timing control unit 41. In addition, the distance image sensor 32 outputs a pixel signal corresponding to an amount of an electric charge distributed to the charge accumulation units. A plurality of pixels are disposed in a two-dimensional matrix form in the distance image sensor 32 which outputs a pixel signal of one frame corresponding to each of pixels.

Here, a range (range of the distance) in a depth direction in which the distance can be measured in a space to be measured to which the distance is measured by the distance image capturing device 1 is mainly determined by light intensity of the light pulse PO emitted from the light source unit 2 and light receiving sensitivity of the light receiving unit 3. In addition, a range in a surface direction in which distance can be measured is determined by an emission angle (spread of light) of the light pulse PO emitted from the light source unit 2 and a light receiving angle (angle at which light can be received) of the light receiving unit 3.

The distance image processing unit 4 has a function as a data processing device that acquires a distance image based on the distance to an object in a space to be measured, performs edge detection on the acquired distance image, and removes a flying pixel (FP). For example, the distance image processing unit 4 controls the distance image capturing device 1 to acquire a distance image by calculating the distance to the object OB, performs edge detection on the acquired distance image, and removes a flying pixel (FP). For example, the distance image processing unit 4 includes the timing control unit 41, a distance calculation unit 42, a measurement control unit 43, an edge detection unit 44, and a noise reduction unit 45.

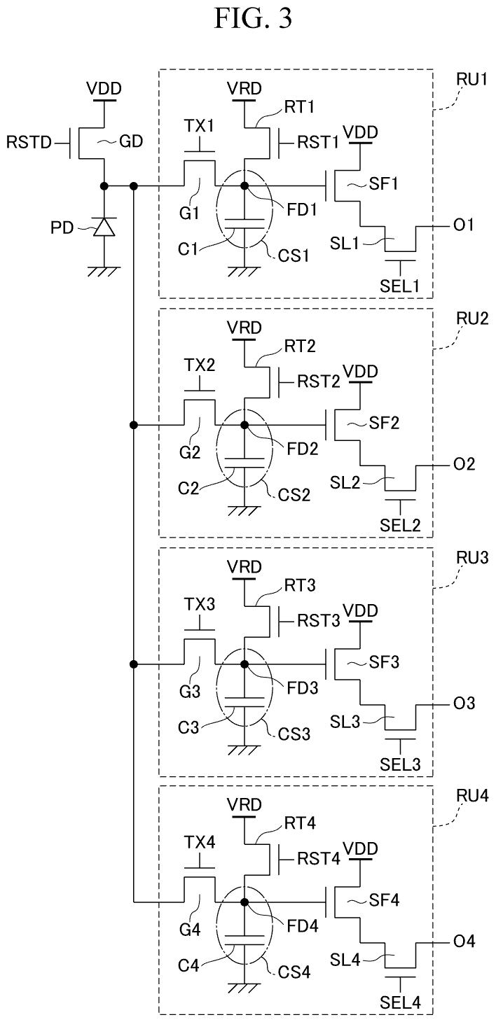

The timing control unit 41 controls timing of outputting various control signals required for measurement under the control of the measurement control unit 43. The various control signals here include, for example, a signal that controls emission of the light pulse PO, a signal that distributes the reflected light RL to the plurality of charge accumulation units and accumulates the distributed light, a signal that controls the number of accumulations per frame, and the like. The number of accumulations is the number of times in which a process of distributing and accumulating electric charges to a charge accumulation unit CS (see FIG. 3) is repeated. Product of the number of accumulations and the time (accumulation time) for accumulating electric charges in the respective charge accumulation units per process of distributing and accumulating the electric charges is an accumulation time.

The distance calculation unit 42 outputs distance information obtained by calculating the distance to the object OB based on the pixel signal output from the distance image sensor 32. The distance calculation unit 42 calculates a delay time from when the light pulse PO is emitted to when the reflected light RL is received, based on the amount of electric charges accumulated in the plurality of charge accumulation units. The distance calculation unit 42 acquires a distance image by calculating the distance to the object OB according to the calculated delay time.

The measurement control unit 43 controls the timing control unit 41. For example, the measurement control unit 43 sets the number of accumulation and an accumulation time of one frame, and controls the timing control unit 41 such that imaging is performed with the set content.

With such a configuration, in the distance image capturing device 1, the light source unit 2 emits the light pulse PO in a near-infrared wavelength band to the object OB, the light receiving unit 3 receives the reflected light RL reflected by the object OB, and the distance image processing unit 4 outputs distance information obtained by measuring the distance to the object OB. For example, the distance image processing unit 4 outputs a distance image as distance information obtained by measuring the distance to the object OB.

The edge detection unit 44 performs edge detection based on distance values of a plurality of pixels of a distance image, and for example, the edge detection unit 44 performs edge detection on respective pixels of the distance image based on a ratio between distance values of the respective pixels or a plurality of pixels around the respective pixels. Specifically, for example, the edge detection unit 44 detects an edge by using a threshold for the calculated ratio value.

The noise reduction unit 45 removes a flying pixel based on the edge detected by the edge detection unit.

Although FIG. 1 shows the distance image capturing device 1 having a configuration in which the distance image processing unit 4 is included in the distance image capturing device 1, the distance image processing unit 4 may be a component provided outside the distance image capturing device 1.

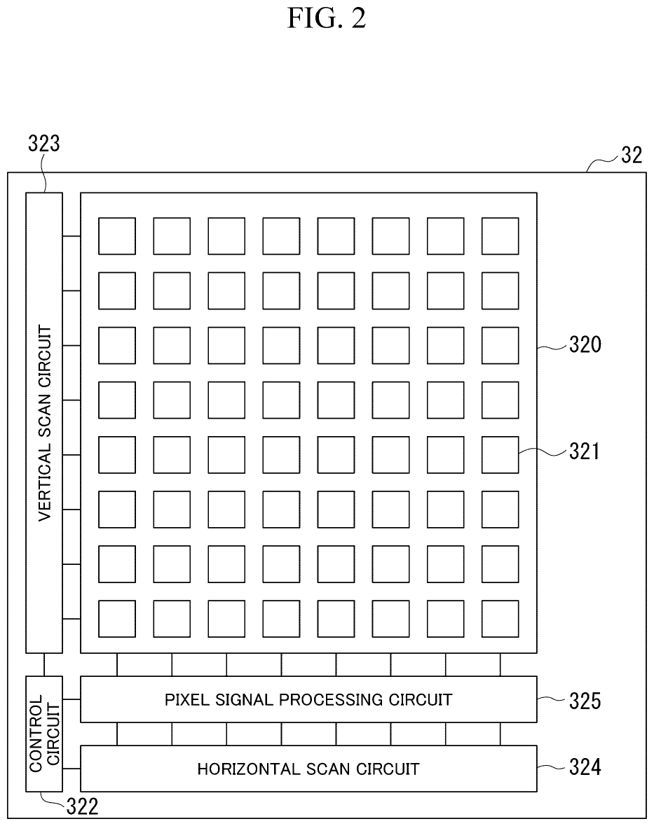

Here, a configuration of the distance image sensor 32 used as an imaging element in the distance image capturing device 1 will be described with reference to FIG. 2. FIG. 2 is a block diagram showing the schematic configuration of an imaging element (distance image sensor 32) used in the distance image capturing device 1 according to the present embodiment.

As shown in FIG. 2, the distance image sensor 32 includes, for example, a light receiving region 320 in which a plurality of pixels 321 are disposed, a control circuit 322, a vertical scan circuit 323 having a distribution operation, a horizontal scan circuit 324, and a pixel signal processing circuit 325.

The light receiving region 320 is a region in which the plurality of pixels 321 are disposed, and FIG. 2 shows an example in which the plurality of pixels 321 are disposed in a two-dimensional matrix form of eight rows and eight columns. The pixel 321 accumulates electric charges corresponding to the amount of received light. The control circuit 322 generally controls the distance image sensor 32. For example, the control circuit 322 controls operations of components of the distance image sensor 32 in response to an instruction from the timing control unit 41 of the distance image processing unit 4. Components included in the distance image sensor 32 may be directly controlled by the timing control unit 41, and in this case, the control circuit 322 can also be omitted.

The vertical scan circuit 323 controls the pixels 321 disposed in the light receiving region 320 in circuits of rows under the control of the control circuit 322. The vertical scan circuit 323 outputs a voltage signal corresponding to the amount of electric charges accumulated in each of the charge accumulation units CS of the pixel 321 to the pixel signal processing circuit 325. In such a case, the vertical scan circuit 323 distributes and accumulates the electric charges converted by the photoelectric conversion element to the charge accumulation units of the pixel 321. That is, the vertical scan circuit 323 is an example of a “pixel drive circuit”.

The pixel signal processing circuit 325 performs predetermined signal processing (for example, noise suppression processing, A/D conversion processing, or the like) on a voltage signal output from the pixels 321 in each column to a corresponding vertical signal line under the control of the control circuit 322.

The horizontal scan circuit 324 sequentially outputs the signals output from the pixel signal processing circuit 325 to horizontal signal lines under the control of the control circuit 322. Thereby, a pixel signal corresponding to the amount of electric charges accumulated for one frame is sequentially output to the distance image processing unit 4 through the horizontal signal line.

Hereinafter, it is assumed that the pixel signal processing circuit 325 performs A/D conversion processing and the pixel signal is a digital signal.

Here, a configuration of each of the pixel 321 disposed in the light receiving region 320 included in the distance image sensor 32 will be described with reference to FIG. 3. FIG. 3 is a circuit diagram showing an example of a configuration of each of the pixels 321 disposed in the light receiving region 320 of the distance image sensor 32 according to the present embodiment. FIG. 3 shows an example of a configuration of one pixel 321 among the plurality of pixels 321 disposed in the light receiving region 320. The pixel 321 is an example of a configuration including four pixel signal read units.

The pixel 321 includes one photoelectric conversion element PD, a drain gate transistor GD, and four pixel signal read units RU that output voltage signals from corresponding output terminals O. Each of the pixel signal read units RU includes a read gate transistor G, a floating diffusion FD, a charge accumulation capacitor C, a reset gate transistor RT, a source follower gate transistor SF, and a selection gate transistor SL. In each of the pixel signal read units RU, the charge accumulation unit CS is configured with the floating diffusion FD and the charge accumulation capacitor C.

In FIG. 3, the pixel signal read units RU are distinguished from each other by adding numbers of “1”, “2”, “3”, or “4” after the symbol “RU” of the four pixel signal read units RU. In addition, similarly, respective components included in the four pixel signal read units RU also represent distinguishably the pixel signal read units RU corresponding to the respective components by adding numbers representing the respective pixel signal read units RU behind the symbol.

In the pixel 321 shown in FIG. 3, a pixel signal read unit RUI that outputs a voltage signal from an output terminal O1 includes a read gate transistor G1, a floating diffusion FD1, a charge accumulation capacitor C1, a reset gate transistor RT1, a source follower gate transistor SF1, and a selection gate transistor SL1. In the pixel signal read unit RU1, the floating diffusion FD1 and the charge accumulation capacitor C1 constitute the charge accumulation unit CS1. The pixel signal read units RU2 to RU4 also have the same configuration.

The photoelectric conversion element PD is an embedded photodiode that performs photoelectric conversion on incident light to generate electric charges and accumulates the generated electric charges. The photoelectric conversion element PD may have any structure. The photoelectric conversion element PD may be, for example, a PN photodiode having a structure in which a P-type semiconductor and an N-type semiconductor are bonded together, or a PIN photodiode having a structure in which an I-type semiconductor is interposed between the P-type semiconductor and the N-type semiconductor. In addition, the photoelectric conversion element PD is not limited to a photodiode, and may be, for example, a photoelectric conversion element of a photo gate type.

In the pixel 321, the photoelectric conversion element PD distributes electric charges generated by performing photoelectric conversion on the incident light to each of the four electric charge accumulation units CS, and outputs respective voltage signals according to the amount of the distributed electric charges to the pixel signal processing circuit 325.

The configuration of the pixel disposed in the distance image sensor 32 is not limited to the configuration including the four pixel signal read units RU shown in FIG. 3, and may be a configuration including a plurality of pixel signal read units RU. That is, the number of pixel signal read units RU (charge accumulation units CS) included in a pixel disposed in the distance image sensor 32 may be two, three, or five or more.

In addition, an example is shown in which the charge accumulation unit CS is configured with the floating diffusion FD and a charge accumulation capacitor C in the pixel 321 having the configuration shown in FIG. 3. However, the charge accumulation unit CS may be configured with at least the floating diffusion FD, and the pixel 321 may not include the charge accumulation capacitor C.

In addition, in the pixel 321 having the configuration shown in FIG. 3, an example of a configuration including a drain gate transistor GD is shown, but when it is not necessary to discard electric charges accumulated (remaining) in the photoelectric conversion element PD, the pixel 321 may be configured not to include the drain gate transistor GD.

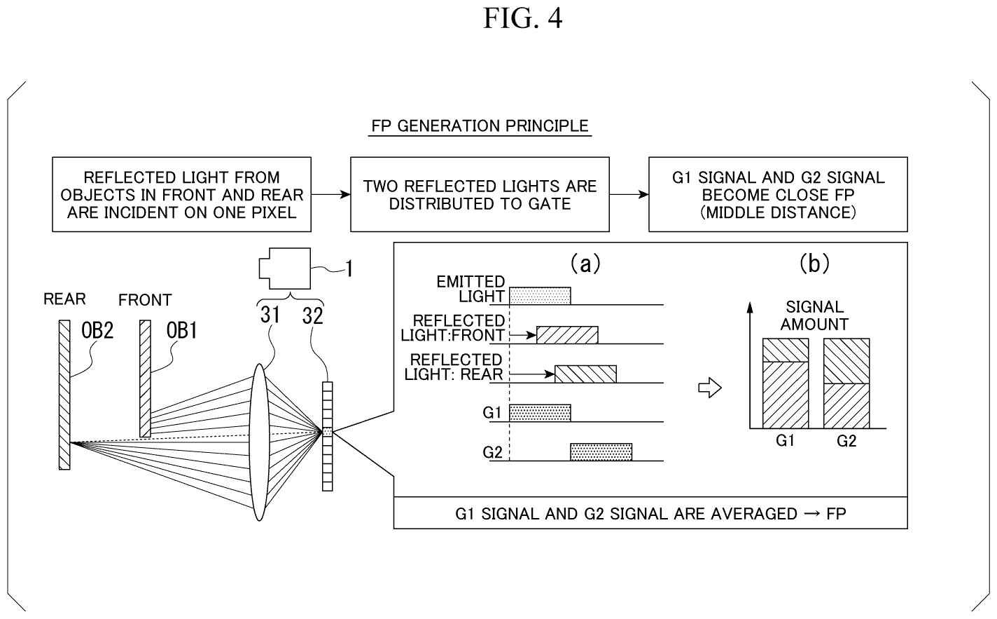

Next, a principle of generating a flying pixel (FP) on an edge of the object OB in a distance image will be described with reference to FIG. 4. FIG. 4 is an explanatory diagram of a principle of generating a flying pixel (FP). In the example shown in FIG. 4, there are an object OB1 in the front and an object OB2 in the rear in a space to be measured of the distance image capturing device 1. In this case, the reflected light from the object OB1 in the front and the reflected light from the object OB2 in the rear are incident on one pixel of the distance image sensor 32.

(a) of FIG. 4 shows time series timing of emitted light, reflected light, and a gate. As shown in (a) of FIG. 4, the reflected light from the front object OB1 is incident with a delay from emission timing of the emitted light, and then the reflected light from the rear object OB2 is incident. The incident two reflected lights are distributed to two gates of a gate transistor G1 and a gate transistor G2. Thereby, as shown in (b) of FIG. 4, signal amounts of a pixel signal of the gate transistor G1 and a pixel signal of the gate transistor G2 are close to each other and averaged, and distance information (actually, distance information in which an object does not exist) indicating an intermediate distance between the object OB1 and the object OB2, that is, a flying pixel (FP) is generated.

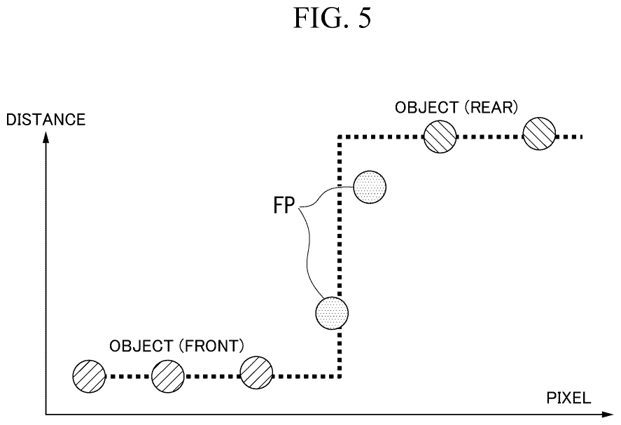

FIG. 5 shows an example of flying pixels (FPs) generated as distance information indicating an intermediate distance between the object OB1 and the object OB2. FIG. 5 is a diagram showing an example of the flying pixels (FPs). In FIG. 5, the vertical axis represents the distance and the horizontal axis represents a pixel, and portions where the flying pixels (FPs) are generated in a distance image are shown. The flying pixels (FPs) are generated on edges of the object OB1 in front and the object OB2 in the rear.

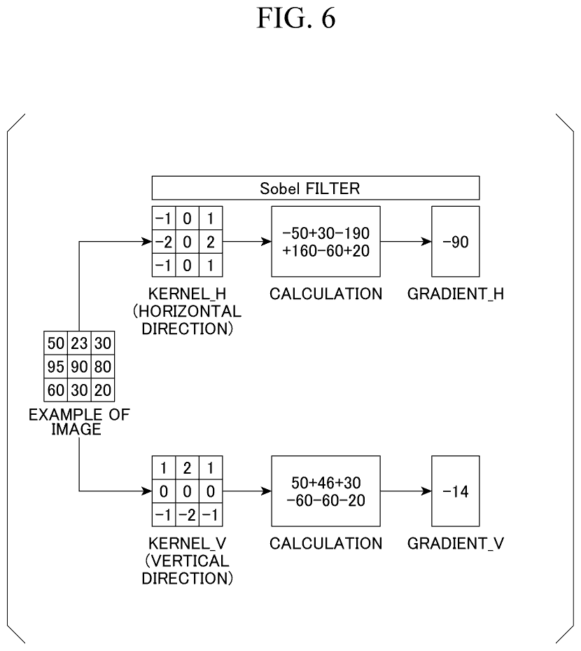

Next, a problem of removing flying pixels (FPs) by a general edge detection method of the related art will be described with reference to FIGS. 6 to 8B. FIG. 6 is an explanatory diagram of an edge detection method using a Sobel filter. The Sobel filter is an example of a differential filter, and can detect an edge by calculating a difference with an adjacent pixel. By applying the Sobel filter to the distance image, edge detection can be performed, and the flying pixels (FPs) can be removed.

In FIG. 6, a kernel His a Sobel filter in a horizontal direction, and a kernel Vis a Sobel filter in a vertical direction. By calculating a gradient H obtained by performing a product-sum operation on a coefficient of the kernel H in the horizontal direction and a distance image, and by calculating a gradient V obtained by performing a product-sum operation on a coefficient of the kernel V in the vertical direction and the distance image, Sobel filter processing in the vertical and horizontal directions is performed. A pixel having a large calculated value is a part of an edge, and a pixel having a small calculated value is a flat part.

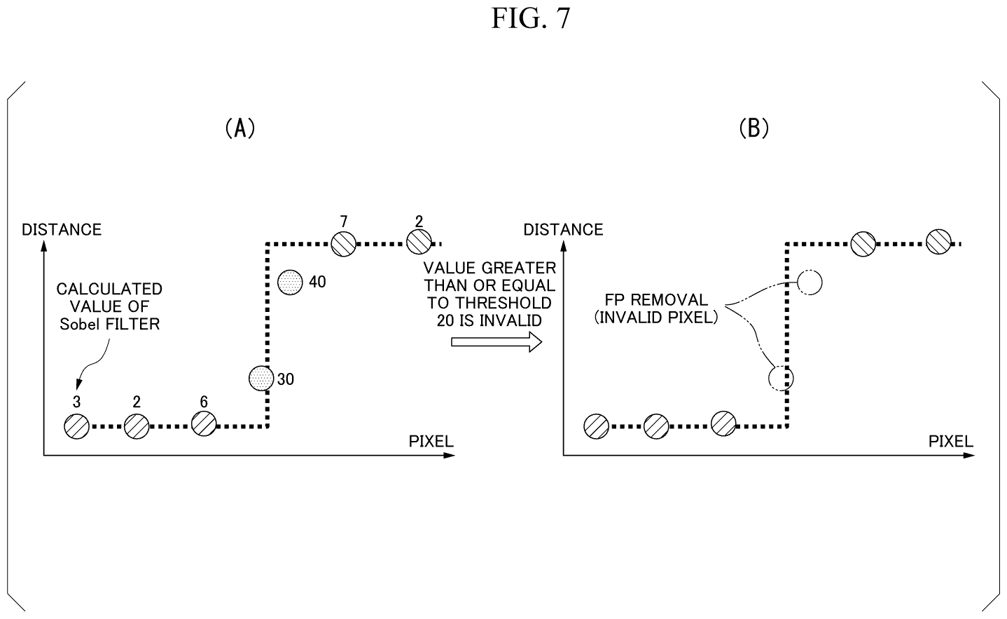

As shown in FIG. 7, flying pixels (FPs) can be removed by determining a calculated value of a Sobel filter as a threshold and determining a pixel greater than or equal to the threshold as an invalid pixel. FIG. 7 is a diagram showing an example of removal of the flying pixels (FPs). In FIG. 7, the vertical axis represents the distance and the horizontal axis represents a pixel, and (A) of FIG. 7 shows the calculated value of a Sobel filter for each pixel as in FIG. 5. By performing the Sobel filter processing shown in FIG. 6, the calculated value of the Sobel filter of the pixel (flying pixel (FP)) of an edge portion is increased. For example, by invalidating the pixel having a calculated value of the Sobel filter that is greater than or equal to a threshold 20, the flying pixel (FP) can be removed as shown in (B) of FIG. 7.

However, in the removal of the flying pixel (FP) by the edge detection method of the related art described with reference to FIGS. 6 and 7, there is a problem that trade-off occurs between the removal of the flying pixel (FP) and the unnecessary invalid pixel (loss of distance information of an actually existing object) other than the flying pixel (FP) due to setting of a threshold.

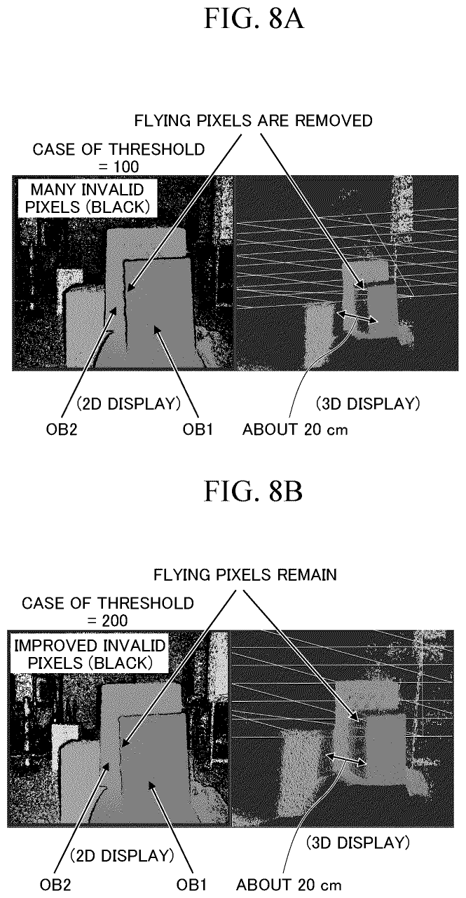

FIGS. 8A and 8B are views showing examples of results of removing flying pixels (FPs) by the edge detection method of the related art. In the example shown in FIGS. 8A and 8B, the object OB1 in the front and the object OB2 in the rear are in a space to be measured as two plates, and the distance between the two plates is about 20 cm. An example of a distance image shown in FIG. 8A is an example in which a threshold for removing the flying pixel (FP) is small (for example, 100). An example of a distance image shown in FIG. 8B is an example in which a threshold for removing the flying pixel (FP) is large (for example, 200). In both FIG. 8A and FIG. 8B, an example of the 2D display of a distance image is shown on the left side, and an example in which an edge portion is shown an example of 3D display to be easily understood is shown on the right side.

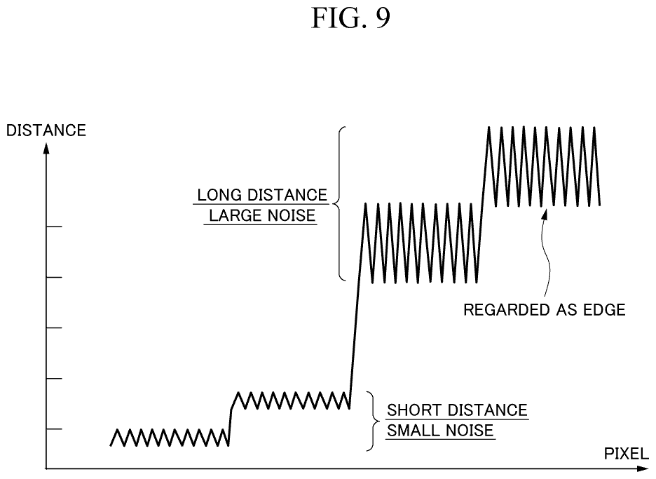

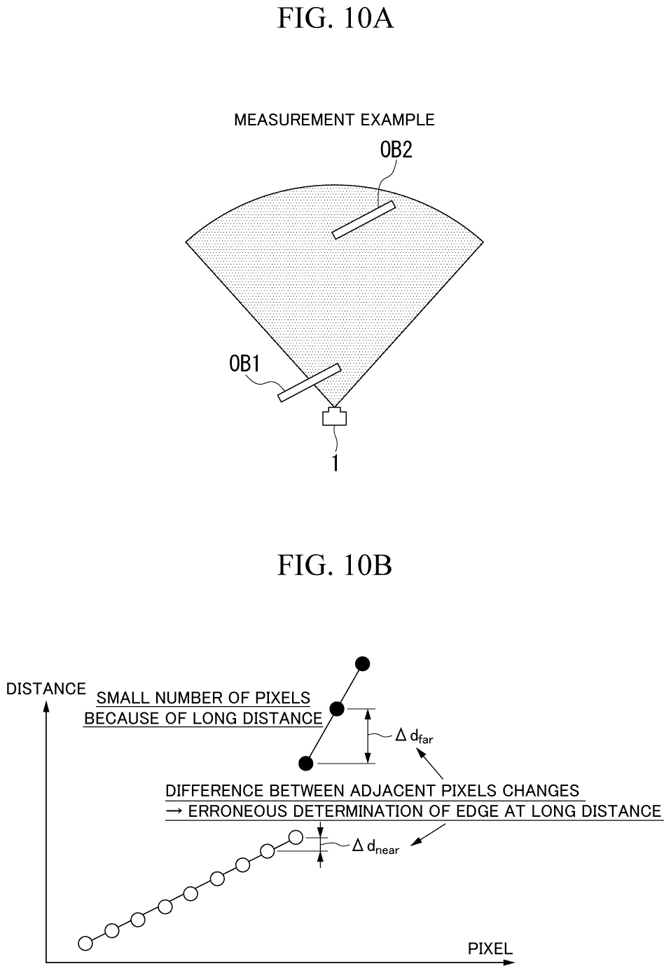

As shown in FIG. 8A, when the threshold is set to be small, the flying pixels (FPs) can be removed in a small edge, but unnecessary invalid pixels (black) other than the flying pixels (FPs) are increased in a background portion or the like. Meanwhile, as shown in FIG. 8B, when the threshold is set to be large, unnecessary invalid pixels (black) are reduced, but flying pixels (FPs) in a small edge remain. As described above, by setting a threshold, trade-off occurs between the removal of the flying pixels (FPs) and the unnecessary invalid pixels other than the flying pixels (FPs), but a mechanism of the trade-off will be described with reference to FIGS. 9, 10A, and 10B.

FIG. 9 is an explanatory diagram of a first example of a mechanism of trade-off. Since the amount of reflected light changes according to the distance to an object in a space to be measured, a signal amount of a pixel signal changes according to the distance to the object. Since a signal amount of an object at a long distance is small, noise increases, and since a signal amount of an object at a short distance is large, the noise is reduced. Since an object at a long distance has a large noise, when a threshold of the Sobel filter is set to be small, the object is regarded as an edge and is determined to be an invalid pixel. When the threshold increases to make pixels of an object at a long distance valid, a flying pixel (FP) of small edge remains.

FIGS. 10A and 10B are explanatory diagrams of a second example of a mechanism of trade-off. As shown in a measurement example of FIG. 10A, it is assumed that an object OB1 in the front (short distance) and an object OB2 in the rear (long distance) are at the same inclination. Here, since the number of pixels in an angle of view is smaller for an object at a long distance, a difference in distance between the adjacent pixels changes even in the same inclination as shown in FIG. 10B. Specifically, even in the same inclination, the difference in distance between the adjacent pixels increases for the object at the long distance than for the object at a short distance (Δd_{far}>Δdₙₑₐᵣ). Accordingly, when an object at a long distance has an inclination, there is a possibility that the object is determined to have an error at an edge and removed as a flying pixel (FP) depending on setting of a threshold.

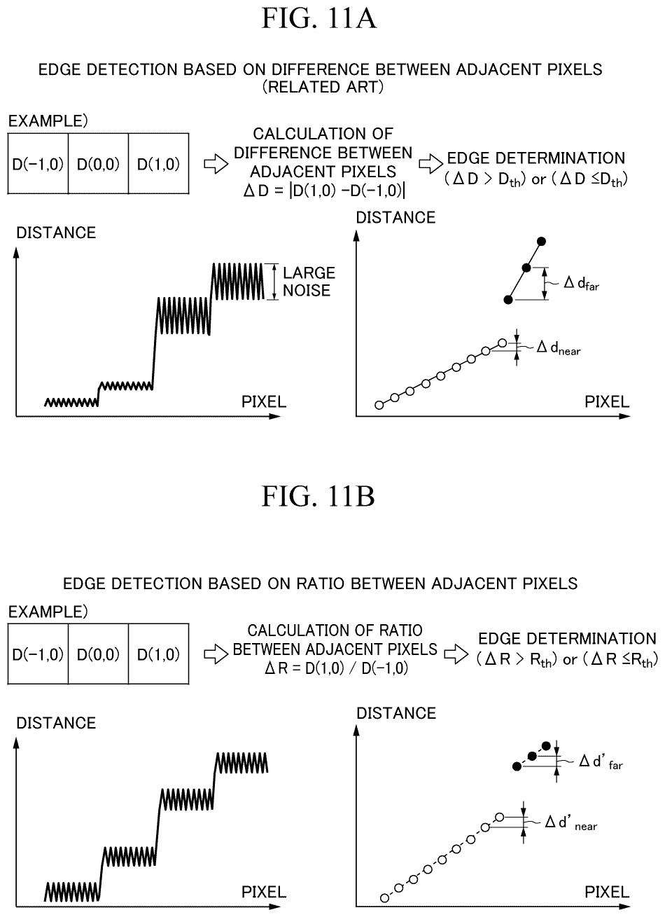

Next, edge detection processing executed by the distance image capturing device 1 according to the present embodiment will be described. FIGS. 11A and 11B are explanatory diagrams showing a basic idea of edge detection according to the present embodiment. In FIGS. 11A and 11B, FIG. 11A shows edge detection of the related art as a comparison target, and FIG. 11B shows edge detection according to the present embodiment. For example, in the edge detection of the related art of FIG. 11A, in an example in which three pixels of D(−1, 0), D(0, 0), and D(1, 0) are disposed, a difference ΔD between adjacent pixels is calculated by “ΔD=|D(1, 0)−D(−1, 0)|”. When it is assumed that a threshold is Dₜₕ, edge is determined depending on whether ΔD is greater than Dₜₕ(ΔD>Dth or ΔD≤Dth). When an edge is detected based on the difference between the adjacent pixels, as described with reference to FIGS. 9 and 10, the influence of a difference in distance between the adjacent pixel, which are caused by noise and inclination that are factors of confusion of an edge according to whether the distance is long or short, affects edge determination, and thus, the edge detection cannot be appropriately performed.

Therefore, in the edge detection according to the present embodiment, determination levels at the long distance and the short distance are aligned by using a ratio between adjacent pixels instead of a difference between the adjacent pixels. For example, in a method of performing edge detection based on the ratio between the adjacent pixels in FIG. 11B, and in an example in which three pixels of D(−1, 0), D(0, 0), and D(1, 0) are disposed, a ratio ΔR of adjacent pixels is calculated by “ΔR=D(1, 0)/D(−1, 0)”. When it is assumed that a threshold is Rₜₕ, edge is determined depending on whether ΔR is greater than Rₜₕ(ΔR>Rth or ΔR<Rth). By using the ratio between adjacent pixels, the difference in distance between the adjacent pixel, which are caused by noise and inclination that are factors of confusion of an edge according to whether the distance is long or short, is aligned, and erroneous determination of an edge can be suppressed.

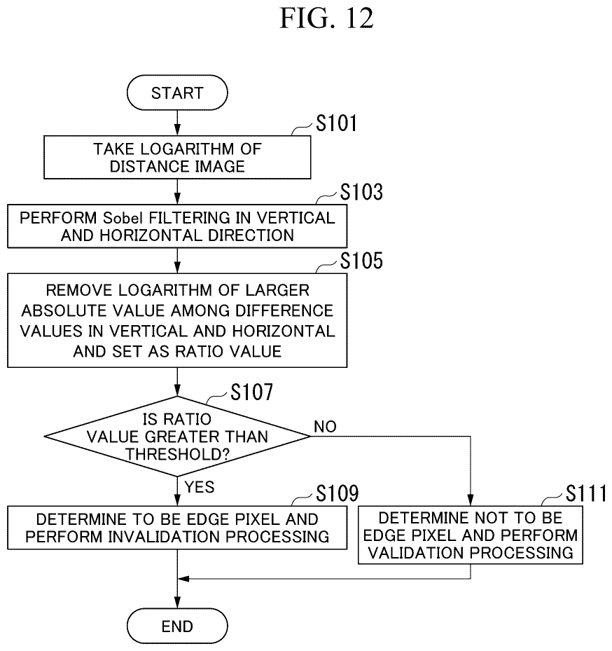

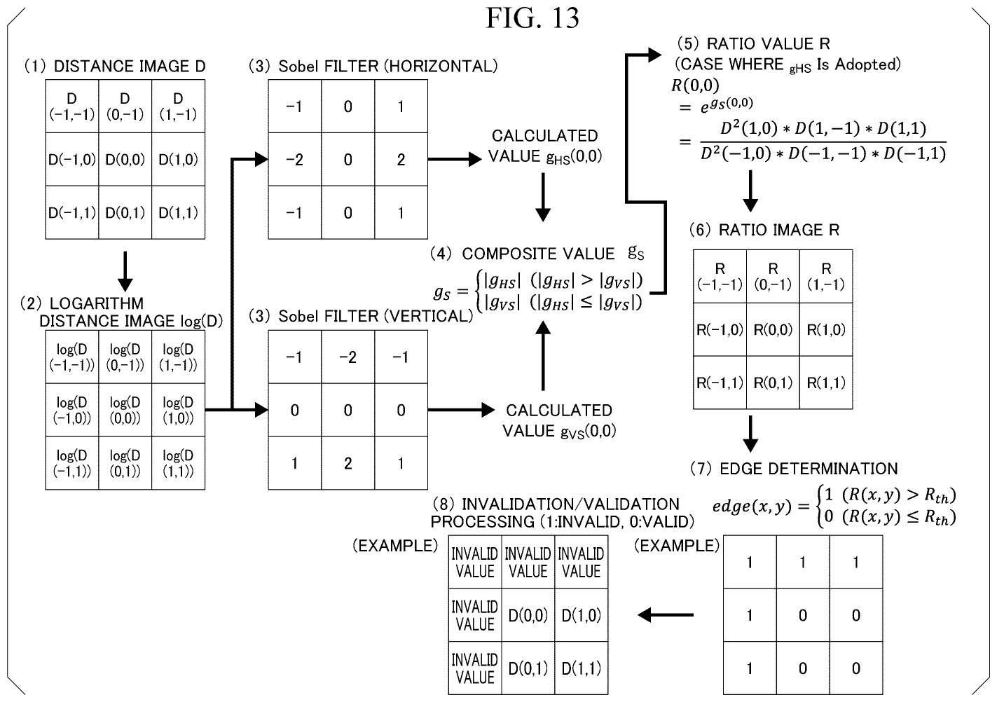

Next, a specific example of the edge detection processing according to the present embodiment will be described with reference to FIGS. 12 and 13. FIG. 12 is a flowchart showing an example of the edge detection processing according to the present embodiment. In addition, FIG. 13 is a diagram showing a specific calculation example of the edge detection processing according to the present embodiment.
(Step S101) The distance image processing unit 4 takes a logarithm of the distance image D (see (1) of FIG. 13) (see a logarithm distance image log(D) of (2) of FIG. 13). Then, a process moves to step S103.
(Step S103) The distance image processing unit 4 performs filtering on the logarithmic distance image log(D) by using Sobel filters (see (3) of FIG. 13) in the vertical direction and the horizontal direction. Then, the process moves to step S105.
(Step S105) The distance image processing unit 4 removes a logarithm of a larger absolute value (see (4) of FIG. 13) among calculated values (difference values) of the Sobel filters in the vertical direction and the horizontal direction, and uses the logarithm as a ratio value (see (5) of FIG. 13). When a value having a larger absolute value is set as a combined value of the Sobel filters among the calculated values (difference values) of the Sobel filters in the vertical direction and the horizontal direction, the combined value is calculated by Equation 1 below.

$$combined value {g}_{S} = \{ \begin{matrix}\vert {g}_{HS} \vert & ( \vert {g}_{HS} \vert > \vert {g}_{VS} \vert ) \\ \vert {g}_{VS} \vert & \vert {g}_{HS} \vert \leq \vert {g}_{VS} \vert )\end{matrix} \qquad Equation 1$$

$$calculated value {g}_{VS} ( 0 , 0 ) of Sobel filter ( vertical )$$

$$calculated value {g}_{HS} ( 0 , 0 ) of Sobel filter ( horizontal )$$

In addition, a ratio value R obtained by removing a logarithm of a combined value of the Sobel filters is calculated by Equation 2 below.

$$Ratio value R ( when {g}_{HS} is applied )$$

$$\begin{matrix}R ( 0 , 0 ) = {e}^{{g}_{S} ( 0 , 0 )} \\ = \frac{{D}^{2} ( 1 , 0 ) * D ( 1 , - 1 ) * D ( 1 , 1 )}{{D}^{2} ( - 1 , 0 ) * D ( - 1 , - 1 ) * D ( - 1 , 1 )}\end{matrix} \qquad Equation 2$$

A ratio image R calculated by applying a Sobel filter to the logarithmic distance image log (D) and calculating a ratio value without a logarithm is shown in (6) of FIG. 13. Then, the process moves to step S107.
(Step S107) The distance image processing unit 4 determines an edge by determining whether the ratio value R is greater than a threshold Rₜₕ. For example, the distance image processing unit 4 determines an edge by using Equation 3 below.

$$edge ( x , y ) = \{ \begin{matrix}1 & ( R ( x , y ) > {R}_{th} ) \\ 0 & ( R ( x , y ) \leq {R}_{th} )\end{matrix} \qquad Equation 3$$

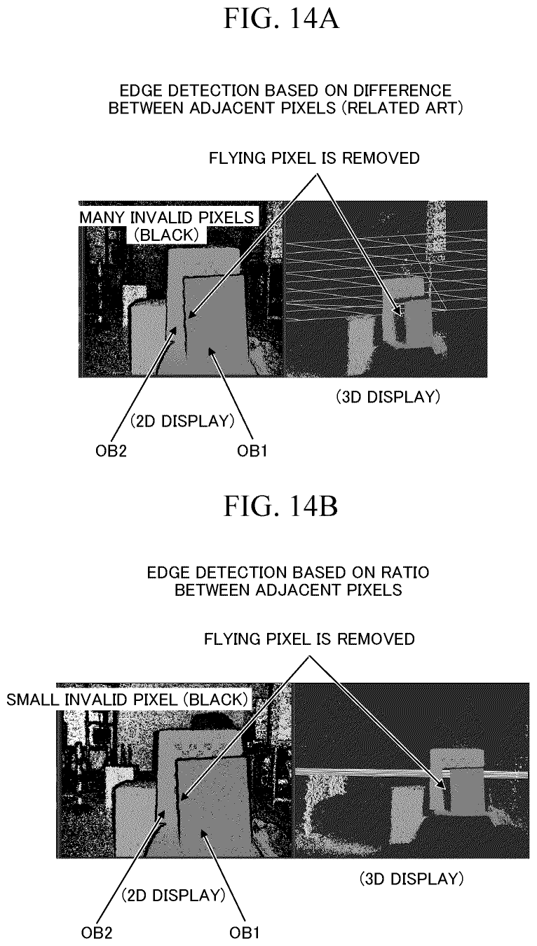

(Step S109) The distance image processing unit 4 determines a pixel in which the ratio value R is greater than the threshold Rₜₕ as an edge pixel based on the determination result of step S107 and sets “1” to the pixel (see (7) of FIG. 13). Then, the distance image processing unit 4 performs invalidation processing for invalidating the pixel (pixel to which “1” is set) determined to be the edge pixel (see (8) in FIG. 13).
(Step S111) The distance image processing unit 4 determines that a pixel having the ratio value R less than or equal to the threshold Rₜₕ is not the edge pixel based on the determination result of step S107 and sets “0” to the pixel (see (7) of FIG. 13). Then, the distance image processing unit 4 performs validity processing for validating the pixel (pixel to which “0” is set) determined as not being the edge pixel (see (8) of FIG. 13).
FIGS. 14A and 14B are views showing examples of results of removing flying pixels (FPs) by performing edge detection according to the present embodiment. In FIGS. 14A and 14B, as a comparison, results of the related art (FIG. 8A) are disposed and described in FIG. 14A. The example of a distance image shown in FIG. 14B is an example of a result of performing edge detection based on a ratio between adjacent pixels of the present embodiment, and unnecessary invalid pixels (black) are reduced while flying pixels (FPs) can be removed. That is, by using the edge detection of the present embodiment, both removal of the flying pixels (FPs) and suppression of the unnecessary invalid pixels can be achieved.

As described above, the distance image capturing device 1 according to the present embodiment includes the light source unit 2, the light receiving unit 3, and the distance image processing unit 4. The light source unit 2 emits the light pulse PO to a space to be measured. The light receiving unit 3 includes the pixel 321 that includes the photoelectric conversion element PD for generating electric charges according to incident light and the plurality of charge accumulation units CS for accumulating electric charges, and the vertical scan circuit 323 (an example of a pixel drive circuit) that distributes and accumulates electric charges to and in each of charge accumulation units CS in the pixel 321 at a predetermined timing synchronized with emission of the light pulse PO. The distance image processing unit 4 includes the distance calculation unit 42 that acquires the distance image by calculating the distance to the object OB in a space based on an amount of electric charges accumulated in each of the plurality of charge accumulation units CS, and the edge detection unit 44 that performs edge detection on respective pixels of the distance image based on the ratio between distance values of the respective pixels or some of a plurality of pixels around the respective pixels.

Thereby, the distance image capturing device 1 performs edge detection in a distance image by using a ratio between adjacent pixels, and accordingly, it is possible to suppress erroneous determination of an edge by aligning a difference in distance between the adjacent pixel, which are caused by noise and inclination that are factors of confusion of an edge according to whether the distance is long or short, and to appropriately perform edge detection. That is, the distance image capturing device 1 can acquire a distance image in which the edge detection is appropriately performed.

That is, the distance image processing unit 4 according to the present embodiment is an example of a data processing device that acquires a distance image based on the distance to an object in a space to be measured. The distance image processing unit 4 performs edge detection on respective pixels of the distance image based on a ratio between distance values of the respective pixels or some of a plurality of pixels around the respective pixels. For example, the distance image processing unit 4 performs edge detection on a distance image based on a ratio between distance values of some of a plurality of pixels in a filtering target region by using a Sobel filter (an example of a differential filter).

Thereby, the distance image processing unit 4 performs edge detection on a distance image by using a ratio between adjacent pixels, and accordingly, it is possible to suppress erroneous determination of an edge by aligning a difference in distance between the adjacent pixel, which are caused by noise and inclination that are factors of confusion of an edge according to whether the distance is long or short, and to appropriately perform edge detection.

For example, when calculating a ratio between distance values of respective pixels of some of a plurality of pixels around the respective pixels for a distance image, the distance image processing unit 4 calculates the ratio by using a logarithm.

Thereby, the distance image processing unit 4 can appropriately perform edge detection on a distance image by calculating the ratio between adjacent pixels by using a logarithm and performing edge detection based on the calculated ratio.

Specifically, for example, when calculating a ratio between distance values of respective pixels or some of a plurality of pixels for the respective pixels of a distance image, the distance image processing unit 4 calculates the ratio between the distance values of the plurality of pixels by applying a Sobel filter (an example of a differential filter) to a logarithm of the distance values of the plurality of pixels and then removing the logarithm.

Thereby, the distance image processing unit 4 can appropriately perform edge detection by calculating a ratio between adjacent pixels by using a logarithm and a Sobel filter (an example of a differential filter) for a distance image and performing edge detection based on the calculated ratio.

For example, the distance image processing unit 4 detects an edge from the calculated ratio value by using a threshold.

Thereby, the distance image processing unit 4 can appropriately perform edge detection by aligning a difference in distance between adjacent pixels caused by noise and inclination which are factors of confusion of an edge depending on whether the distance is a long distance or a short distance, and then determining the edge by using a threshold.

In addition, the distance image processing unit 4 removes a flying pixel (FP) based on the detected edge.

Thereby, the distance image processing unit 4 can appropriately remove a flying pixel (FP) while suppressing an unnecessary invalid pixel.

In addition, an edge detection method of a distance image in the distance image processing unit 4 (an example of a data processing device) according to the present embodiment includes a step of acquiring the distance image based on the distance to an object in a space to be measured by an acquisition unit, and a step of performing edge detection on respective pixels of the distance image based on a ratio between distance values of the respective pixels or some of a plurality of pixels around the respective pixels by an edge detection unit.

Thereby, the edge detection method of the distance image in the distance image processing unit 4 performs edge detection by using a ratio between adjacent pixels, and accordingly, it is possible to suppress erroneous determination of an edge by aligning a difference in distance between the adjacent pixel, which are caused by noise and inclination that are factors of confusion of an edge according to whether the distance is long or short, and to appropriately perform edge detection.

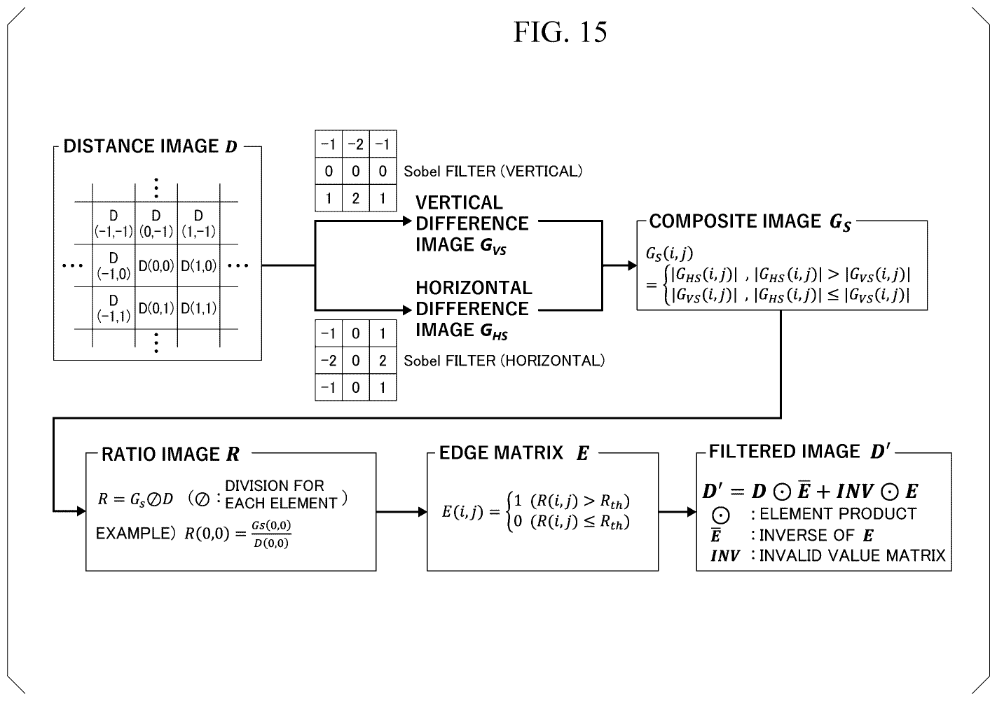

In the above-described embodiment, an example (see FIG. 13) in which a ratio between adjacent pixels is calculated by using a logarithm (log) when calculating the ratio between the adjacent pixels in a distance image is described, but the logarithm may not be used. FIG. 15 is a diagram showing another example of the edge detection processing and a calculation example in which edge detection is performed by calculating a ratio between adjacent pixels without using a logarithm. In this example, the ratio is calculated by dividing a difference value between adjacent pixels of a pixel of interest by a value of the pixel of interest.

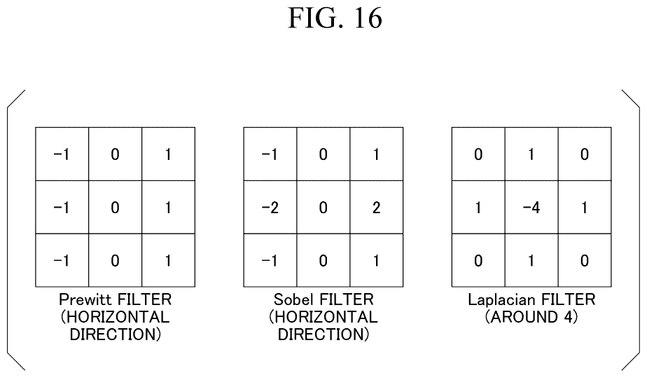

In addition, in the above-described embodiment, an example in which the Sobel filter is used at the time of edge detection is shown, but the present disclosure is not limited to the Sobel filter, and another differential filter may be used. For example, a Prewitt filter, a Laplacian filter, or the like may be used instead of the Sobel filter. FIG. 16 is a diagram showing an example of a differential filter. The Sobel filter and the Prewitt filter are first-order differential filters, and the Laplacian filter is a second-order differential filter.

In addition, the distance image processing unit 4 (an example of a data processing device) has a function as an acquisition unit that acquires a distance image but is not limited to a configuration in which a distance image is acquired by controlling the light source unit 2 and the light receiving unit 3. For example, the distance image processing unit 4 (an example of a data processing device) may acquire a distance image from another device, and may similarly perform edge detection on the acquired distance image to remove a flying pixel (FP). In addition, the distance image is not limited to a distance image measured (distance-measured) by using a TOF method, and may be a distance image obtained by using any method.

All or a part of the distance image processing unit 4 in the above-described embodiment may be implemented by a computer. In this case, a program for implementing the function may be recorded on a computer-readable recording medium, and a computer system may read and execute the program recorded on the recording medium to implement the function. It is assumed that a “computer system” described herein includes an OS and hardware such as a peripheral device. In addition, a “computer-readable recording medium” refers to, for example, a portable medium such as a flexible disk, a magneto-optical disk, ROM, or CD-ROM, a storage device such as a hard disk embedded in a computer system, or the like. Furthermore, a “computer-readable recording medium” may include a thing that dynamically stores a program for a short period of time, such as a communication line when transmitting the program through a network such as the Internet or a communication line such as a telephone line, and a thing that stores a program for a certain period of time, such as a server or a volatile memory in a computer system that becomes a client in that case. In addition, the program may implement a part of the above-described function, may further implement the above-described functions in combination with a program previously recorded in a computer system, or may be implemented by using a programmable logic device such as an FPGA.

As described above, although embodiments of the present invention are described in detail with reference to the drawings, the specific configuration is not limited to the embodiments and also includes design and the like in a scope that does not deviate from the gist of the present invention. The embodiments of the present invention should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A data processing device comprising:
an acquisition unit configured to acquire a distance image based on a distance to an object in a space to be measured; and
an edge detection unit configured to perform edge detection on each pixel of the distance image based on a ratio of distance values of the pixel or of any plurality of pixels around the pixel.

2. The data processing device according to claim 1,
wherein, when calculating the ratio between the distance values of the respective pixels or the some pixels among the plurality of pixels around the respective pixels, the edge detection unit performs calculation by using a logarithm for the respective pixels of the distance image.

3. The data processing device according to claim 2,
wherein, when calculating the ratio between the distance values of the respective pixels or the some pixels among the plurality of pixels around the respective pixels, the edge detection unit calculates the ratio between the distance values of the plurality of pixels by applying a differential filter to logarithms of the distance values of the plurality of pixels for the respective pixels of the distance image and then removing the logarithms.

4. The data processing device according to claim 1,
wherein the edge detection unit detects an edge from a calculated ratio value by using a threshold.

5. The data processing device according to claim 1, further comprising:
wherein the edge detection unit calculates the ratio between the distance values of the plurality of pixels by removing logarithms of a larger absolute value among values filtered using a differential filter in a vertical direction and a horizontal direction, to logarithms of the distance values of the plurality of pixels, when calculating the ratio between the distance values of the respective pixels or the some pixels among the plurality of pixels around the respective pixels, and
the edge detection unit detects edges by determining a pixel in which the calculated ratio value is greater than a predetermined threshold as an edge pixel.

6. The data processing device according to claim 1, further comprising:
a noise reduction unit configured to remove a flying pixel based on an edge detected by the edge detection unit.

7. A distance image capturing device comprising:
a light source unit configured to emit a light pulse to a space to be measured;
a light receiving unit that includes a pixel including a photoelectric conversion element for generating electric charges according to incident light and a plurality of charge accumulation units accumulating the electric charges and a pixel drive circuit which distributes and accumulates the electric charges in each of the charge accumulation units in the pixel at a predetermined timing synchronized with emission of the light pulse;
a distance calculation unit configured to acquire a distance image by calculating a distance to an object in the space based on an amount of the electric charges accumulated in each of the charge accumulation units; and
an edge detection unit configured to perform edge detection on respective pixels of the distance image based on a ratio between distance values of the respective pixels or some of a plurality of pixels around the respective pixels.

8. An edge detection method of a distance image in a data processing device, the method comprising:
a step of acquiring, by an acquisition unit, the distance image based on a distance to an object in a space to be measured; and
a step of performing, by an edge detection unit, edge detection on respective pixels of the distance image based on a ratio between distance values of the respective pixels or some of a plurality of pixels around the respective pixels.
